(19) United States
(12) Patent Application Publication
(10) Pub. No.: US 2021/0272408 A1
(43) Pub. Date: Sep. 2, 2021

(54) TRANSACTION DEVICE

(71) Applicant: Oki Electric Industry Co., Ltd., Tokyo (JP)

(72) Inventor: Motomitsu KIKUCHI, Tokyo (JP)

(73) Assignee: Oki Electric Industry Co., Ltd., Tokyo (JP)

(21) Appl. No.: 17/252,611

(22) PCT Filed: Jun. 18, 2019
(86) PCT No.: PCT/JP2019/024122

§ 371 Date: Dec. 15, 2020

(30) Foreign Application Priority Data
Aug. 6, 2018 (JP) 2018-147671

(51) Int. Cl. G07D 11/26; G07D 11/60; G07F 19/00; G06Q 20/10

(52) U.S. Cl. CPC G07D 11/26; G07D 11/60; G06Q 20/1085; G07F 19/203; G07F 19/202

(57) ABSTRACT

A transaction device including: a banknote deposit/withdrawal port section that receives at least one of a deposit banknote or a withdrawal banknote; a storage box that stores banknotes; a conveyance section including a conveyance path on which the banknotes are conveyed between the banknote deposit/withdrawal port section and the storage box; a banknote identification information holding section that reads and holds banknote identification information of the banknotes conveyed on the conveyance path; a storage detection section that detects the banknotes being stored in the storage box via the conveyance path or being fed out from the storage box via the conveyance path; and an information presentation section that presents the banknote identification information obtained from the banknote identification information holding section associated with a detection result of the storage detection section in a case in which a fault event has arisen.

### TECHNICAL FIELD

The present disclosure relates to a transaction device.

### BACKGROUND ART

Typical examples of known transaction devices in financial institutions include automated teller machines (ATMs) and cash dispensers (CDs). Both banknotes (user banknotes) deposited by a user and banknotes either loaded into the device or from a previous transaction (in-box banknotes) are present inside such transaction devices (Japanese Patent Application Laid-Open (JP-A) No. 2014-81839).

### SUMMARY OF INVENTION

### Technical Problem

In cases in which a temporarily holding section is not installed in conventional transaction devices, there is no means for a user to check the amount that they have deposited, since deposited banknotes are counted and then go on to be stored in a storage box. Accordingly, in cases in which trouble such as a banknote conveyance jam arises in the transaction device, even when a maintenance technician arrives to deal with this trouble, since any user banknotes inside the device that should be returned to the user are mixed in with the in-box banknotes, it is difficult to accurately judge which banknotes are user banknotes and which are in-box banknotes. Accordingly, the maintenance technician tasked with correcting the jam or other trouble may inadvertently hand over in-box banknotes to the user.

The present disclosure provides a transaction device that enables banknotes recovered from inside the device by a maintenance technician to be correctly handled, even in cases in which a fault has arisen during banknote transaction processing such as deposit processing, causing banknotes to remain inside the device at a location other than a storage box.

### Solution to Problem

A first aspect of the present disclosure is a transaction device including: a banknote deposit/withdrawal (pay-in/pay-out) port section that receives at least one of a deposit banknote or a withdrawal banknote; a storage box that stores banknotes; a conveyance section including a conveyance path on which the banknotes are conveyed between the banknote deposit/withdrawal port section and the storage box; a banknote identification information holding section that reads and holds banknote identification information of the banknotes conveyed on the conveyance path; a storage detection section that detects the banknotes being stored in the storage box via the conveyance path or being fed out from the storage box via the conveyance path; and an information presentation section that presents the banknote identification information obtained from the banknote identification information holding section associated with a detection result of the storage detection section in a case in which a fault event has arisen.

### BRIEF DESCRIPTION OF DRAWINGS

FIG. 1 is a block diagram illustrating a configuration of a transaction device system according to a first exemplary embodiment of the present disclosure.

FIG. 2 is a diagram illustrating a configuration of a banknote deposit/withdrawal device configuring a transaction device according to the first exemplary embodiment.

FIG. 3 is an explanatory diagram illustrating an example of a banknote identification data configuration stored in a banknote identification information storage section of a banknote deposit/withdrawal device configuring a transaction device according to the first exemplary embodiment.

FIG. 4 illustrates a flow of deposit processing in the first exemplary embodiment according to the present disclosure.

FIG. 5 illustrates a flow of banknote recovery and rectification processing performed by a maintenance technician after a fault has arisen in the first exemplary embodiment of the present disclosure.

FIG. 6 illustrates a flow of deposit transaction processing of a second exemplary embodiment of the present disclosure.

FIG. 7 is a diagram illustrating a configuration of a banknote deposit/withdrawal device installed with a temporary storage section according to a modified example of an exemplary embodiment of the present disclosure.

### DESCRIPTION OF EMBODIMENTS

Detailed explanation follows regarding exemplary embodiments of the present disclosure. Note that in the following explanation and in the attached drawings, portions that are substantially the same as or equivalent to each other are allocated the same reference numerals.

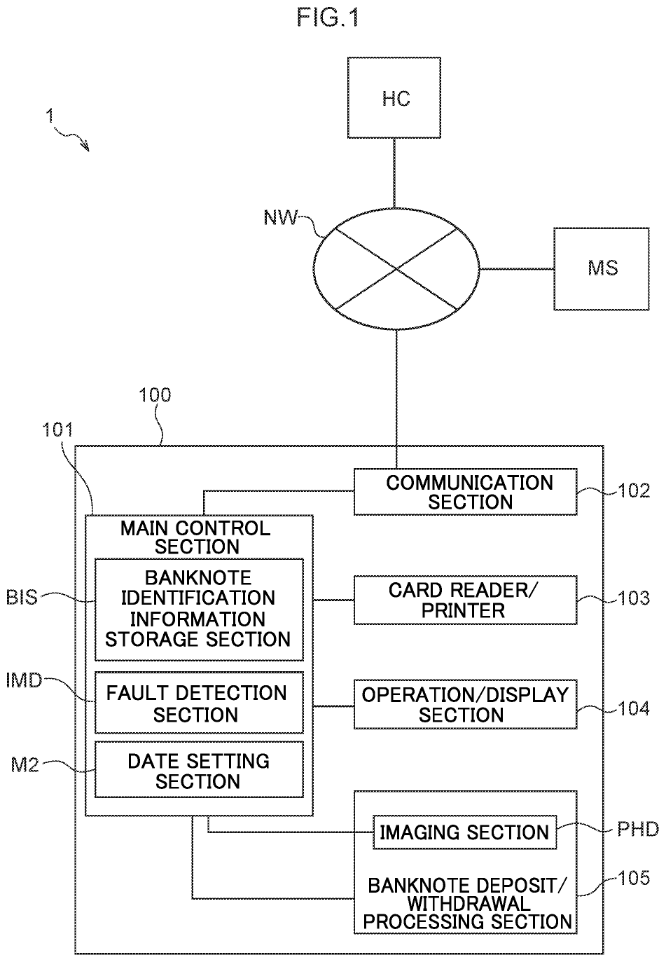

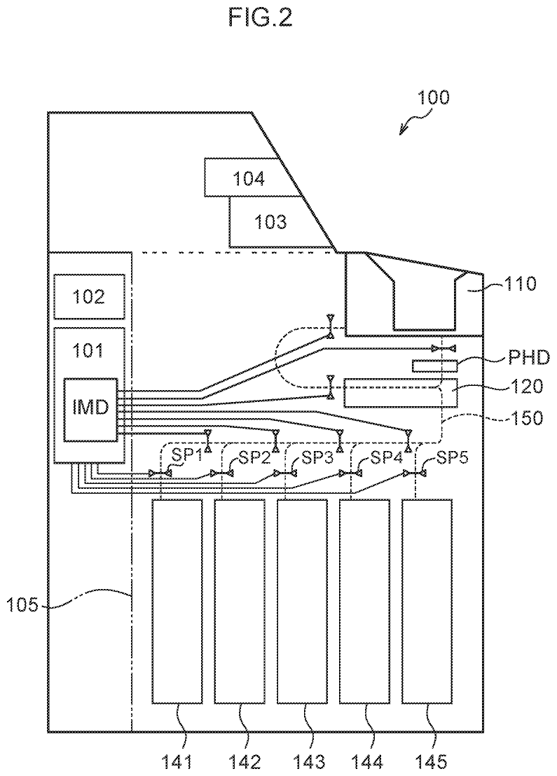

In the exemplary embodiments described below, explanation is given regarding a case in which a transaction device according to the present disclosure is a banknote deposit/withdrawal device. FIG. 1 is a block diagram illustrating configuration of a transaction device system 1 according to exemplary embodiments of the present disclosure. FIG. 2 is a diagram illustrating configuration of the banknote deposit/withdrawal device configuring the transaction device according to exemplary embodiments of the present disclosure. The banknote deposit/withdrawal device is installed in a branch of a financial institution or the like, and configures a transaction device capable of at least banknote deposit transaction processing in response to user (customer) operation. Note that in addition to user (customer) operation, the banknote deposit/withdrawal device may also be operated by a maintenance technician of the financial institution or the like that manages the device.

Internal Configuration of Banknote Deposit/withdrawal Device of a First Exemplary Embodiment

As illustrated in FIG. 1, a banknote deposit/withdrawal device 100 includes a main control section 101, a communication section 102, a card reader/printer 103 (user verification section), an operation/display section 104, and a banknote deposit/withdrawal processing section 105.

The main control section 101 is configured by circuitry including a central processing unit (CPU), a storage section (read only memory (ROM), random access memory (RAM), a hard disk drive (HDD), a solid state drive (SSD), or the like), an input/output interface, and the like. The main control section 101 controls the various units including the communication section 102, the card reader/printer 103, the operation/display section 104, the banknote deposit/withdrawal processing section 105, as well as a banknote conveyance section 150 (FIG. 2), based on a control program (software) held in the storage section. Note that the banknote deposit/withdrawal device 100 has a unique device ID, this device ID being stored in the storage section. The device ID is, for example, employed as address information to specify the banknote deposit/withdrawal device 100 when an anomaly has been determined to exist. As well as the device ID, for example, an installation location (store code) or the like may also be stored in the storage section of the main control section 101 as an identification code of the banknote deposit/withdrawal device 100.

The main control section 101 receives user operation via the operation/display section 104, and executes functionality such as withdrawal processing, deposit processing, and counting processing. The main control section 101 includes a calendar function and a clock function, and includes date setting functionality (a date setting section M2) to set the date used to keep track of the date and time of a system date and time used as a system reference, and to store settlement dates and fault occurrence times in the storage section.

As illustrated in FIG. 1 and FIG. 2, the communication section 102 is connected to the main control section 101 and a communication line-based network NW, and is configured by a network interface card (NIC) or the like configured to exchange data with external equipment such as a host computer HC and a monitoring server MS. For example, the communication section 102 communicates with the host computer HC during transaction control of the banknote deposit/withdrawal device 100 according to instructions from the main control section 101. The host computer HC includes a database (not illustrated in the drawings) in which customer information and the like is held. The banknote deposit/withdrawal device 100 accesses this database in order to perform transaction processing with a customer (a user operating the banknote deposit/withdrawal device 100).

As a result of communication between the communication section 102 and a higher-tier device, the date setting section M2 of the main control section 101 stores time and date information including a system time and date and settlement dates acquired from the higher-tier device in the storage section, and sets the date and time (performs synchronization settings).

The card reader/printer 103 is a user verification section, and is provided on a front side of the banknote deposit/withdrawal device 100. The card reader/printer 103 includes a card insertion/discharge port (not illustrated in the drawings) that outputs transaction slips printed with transaction contents. At the beginning of a transaction, the card reader/printer 103 reads information held on a recording medium such as a user cash card or transaction card, and supplies the read customer data to the main control section 101. For example, the card reader/printer 103 reads user identification information (for example name, account number, and so on) recorded on a cash card. Note that the card reader/printer 103 may be capable of reading information such as user identification information from various media, including magnetic cards, IC cards, and so on. The card reader/printer 103 is capable of printing a transaction slip with a transaction result expressed by a transaction detail print signal when the transaction detail print signal is supplied from the main control section 101. In cases in which the card reader/printer 103 has been supplied with a card discharge signal from the main control section 101, the transaction card in the device is discharged through the card insertion/discharge port. Note that in addition to the card reader/printer 103, the banknote deposit/withdrawal processing section 105 may also be provided with a passbook reader/printer (not illustrated in the drawings) connected to the main control section 101 to read passbooks recorded with user identification information (for example name, account number, and so on).

The operation/display section 104 receives user operation, and displays operation/input guidance, transaction contents, and the like for the user. The operation/display section 104 is an input reception section that receives user operation during a transaction and functions as a display means to display operation states and the like. The operation/display section 104 is a touch panel or the like configured by a display screen such as a liquid crystal display, and a contact input means overlaid thereon. The operation/display section 104 includes functionality to display instruction buttons and the like on the display screen for a user to instruct deposit processing, withdrawal processing, or the like.

As illustrated in FIG. 2, the banknote deposit/withdrawal processing section 105 is configured by a banknote deposit/withdrawal port section 110, a classification section 120, storage boxes 141 to 145, and the conveyance section 150 that includes a banknote conveyance path (see dashed lines) linking these sections together.

The banknote deposit/withdrawal device 100 is provided with plural detection sensors such as optical sensors, magnetic sensors, or the like that are capable of detecting banknotes on the conveyance path of the conveyance section 150. A fault detection section IMD of the main control section 101 receives a signal from the detection sensors when an anomaly (fault such as a jam) has been detected. The main control section 101 stops the conveyance section 150 in response. The fault detection section IMD uses predetermined sensors to detect anomalies not only of the conveyance section 150 but also of the respective units inside the device.

The main control section 101 performs timing monitoring of the arrival and passage of banknotes between the detection sensors on the conveyance path over predetermined durations.

For example, the inter-detection sensor timing monitoring performed by the main control section 101 detects “ON” for the arrival of a banknote at a given detection sensor, and “OFF” for the passage of the banknote past the detection sensor. The inter-detection sensor monitoring is performed for each detection sensor until a conveyance destination. In cases in which “ON” and “OFF” cannot be detected for an en-route detection sensor within the monitoring timing, this is treated as a banknote conveyance path holdup (jam detection). The detection sensors are disposed at predetermined locations on the conveyance path 150 between predetermined conveyance destinations and blades (not illustrated: plates used to switch between branches on the conveyance path during banknote conveyance). Note that various numbers and locations may be allocated as the numbers and locations of the installed detection sensors.

The banknote deposit/withdrawal port section 110 includes a banknote deposit port into which banknotes are deposited and a space in which banknotes are housed, and is configured by a unit to feed the banknotes into the banknote conveyance path one note at a time. The banknote deposit/withdrawal port section 110 also configures a withdrawal port through which banknotes to be returned when deposit is cancelled are paid out (discharged). An opening of the banknote deposit/withdrawal port section 110 is provided with a shutter (not illustrated in the drawings). When the shutter is placed in a closed state, collected banknotes inside the banknote deposit/withdrawal port section 110 cannot be taken out by the user, and when the shutter is placed in an open state, the collected banknotes can be taken out by the user.

As illustrated in FIG. 2, the plural storage boxes 141 to 145 are cassette-type storage boxes that store banknotes in a stacked state. Of these storage boxes, the storage box 141 is a reject storage box used to store banknotes that are creased, unsuited for withdrawal, or the like. The storage boxes 142 to 145 are employed to circulate banknotes of respective denominations. Storage passage sensors SP1 to SP5 that transmit signals to the main control section 101 are provided at banknote entry/exit ports of the respective storage boxes 141 to 145 to and from the banknote conveyance path. Note that although not illustrated in the drawings, a retrieval/replenishment cassette storage box, a forgotten banknote cassette storage box, and the like may also be provided. The storage passage sensors SP1 to SP5 associate the positions of banknotes before and after passing the respective sensor with identification information such as images or serial numbers of the respective banknotes.

The classification section 120 acquires information such as captured images of banknotes conveyed within the banknote deposit/withdrawal device 100, the strength of reflected light from the banknotes, the distribution of magnetic bodies in the banknotes, or the like, and classifies states of the banknotes, for example whether the banknotes are authentic notes or counterfeit notes, whether the banknotes are damaged notes or are being conveyed in an overlapping state, whether the banknotes are face-up or face-down, and so on. For example, the classification section 120 classifies conveyed banknotes when the banknotes are conveyed during deposit or withdrawal.

An imaging section PHD images banknotes prior to classification by the classification section 120, and outputs captured digital data to the main control section 101. A digital camera or a line sensor capable of imaging the banknotes using macro photography may be applied as the imaging section PHD. The images (banknote images) captured by the imaging section PHD are images to be presented to a maintenance technician, and are thus captured by illuminating the banknotes with visible light. Note that the digital data of the banknote images is referred to as banknote image data.

In the present exemplary embodiment, it is sufficient that the imaging section PHD output only banknote image data of at least a front face of a banknote (a face printed with the banknote serial number, this being a banknote identification code). In cases in which it is possible to hold image data by imaging a banknote (imaging using an optical sensor for visible light) during the classification processing performed by the classification section 120, the functionality of the imaging section PHD may be consolidated in the classification section 120.

As illustrated in FIG. 1, the storage section of the main control section 101 includes a banknote identification information storage section BIS. The banknote identification information storage section BIS stores (holds) image data (referred to hereafter as banknote identification information (also referred to as banknote identification data)) of banknotes imaged during a deposit transaction performed by the banknote deposit/withdrawal device 100. The imaging section PHD and the main control section 101 configure a banknote identification information holding section configured to read and hold banknote identification information of banknotes conveyed on the conveyance path.

Moreover, the banknote identification information storage section BIS is capable of including an image of a banknote, or a serial number (banknote identification code) extracted from this image by the main control section 101, in the banknote identification data relating to a deposit transaction.

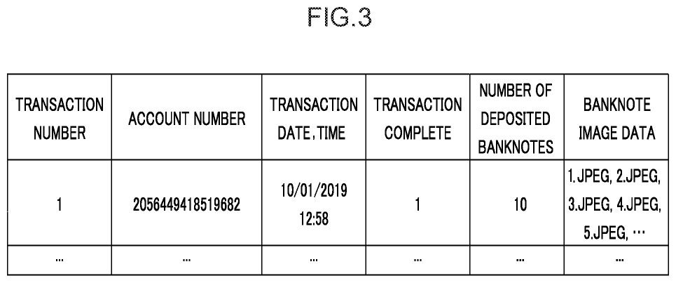

FIG. 3 is an explanatory diagram illustrating an example of configuration of the banknote identification data stored in the banknote identification information storage section BIS.

Although FIG. 3 illustrates the banknote identification data for a single transaction in a single table, the specific data configuration is not limited thereto. In the case of transactions performed using the banknote deposit/withdrawal device 100 of the present exemplary embodiment, each transaction is allocated a transaction number as identification information for this transaction. Note that each transaction is allocated a transaction number in ascending order according to the transaction time. In FIG. 3, banknote identification data for the respective transactions corresponding to transaction numbers 1, 2, 3, and so on is expressed as 1.JPEG, 2.JPEG, 3.JPEG, 4.JPEG, 5.JPEG and so on.

Moreover, in the example in FIG. 3, banknote identification data D1 for a deposit transaction is configured by data for the respective fields of: transaction number; account number; transaction date and time; transaction complete; number of deposited banknotes, and banknote image data.

The “account number” field indicates a number read from the cash card of the user during the deposit transaction.

The “transaction date and time” field indicates the date and time when the transaction was performed (for example, the date and time at which the banknote identification data was registered).

The “account number” field indicates a number read from the cash card of a user during the deposit transaction.

The “transaction complete” field is recorded with a “1” in cases in which the deposit transaction has been completed, and is recorded with a “0” in cases in which the deposit transaction is incomplete.

The “number of deposited banknotes” field indicates the number of deposited banknotes that have completed deposit (pay-in) by the user during the deposit transaction, namely that were imaged and stored in a storage box.

The “banknote image data” field holds banknote image data for each banknote deposited by a user, numbered in sequence of capture by the imaging section PHD (namely, applied with a file name of a file in which the banknote image data is held). Although the data format used for these banknote image data files is a JPEG format in this example, there is no limitation thereto. In the banknote image data field, management numbers are allocated to plural banknotes in ascending order according to the capture sequence by the imaging section PHD. Thus “banknote image data” for “incomplete” also exists in cases in which the number of files in the “banknote image data” field is greater than the “number of deposited banknotes”.

Note that in the present exemplary embodiment, explanation is only given regarding deposit transactions by the banknote deposit/withdrawal device 100. However, banknote identification data may additionally be recorded to accommodate other transactions of the automatic transaction device (for example a “1” for deposit transactions to a bank account, and a “2” for withdrawal transactions from a bank account).

The main control section 101 includes functionality to perform processing to present the user with a captured image of a banknote (pre-imaged banknote) in cases in which a jam or the like has arisen during a deposit transaction and start-up has been performed in recovery mode. The main control section 101 also performs processing to generate banknote identification data and register this in the banknote identification information storage section BIS of the storage section when deposit transaction processing is performed.

The main control section 101 is also capable of outputting banknote identification data stored (held) in the banknote identification information storage section BIS in response to operation by a maintenance technician or the like.

For example, either one or both out of printing-based output or display-based output may be executed by the main control section 101 as the method of outputting banknote identification data. Moreover, the data configuration when the main control section 101 outputs the banknote identification data is not limited. The maintenance technician is able to validate transaction contents performed by a user by specifying and reading the banknote identification data relating to the transaction that was being performed by the user in response to a user enquiry based on the thus acquired banknote identification data.

Operation of First Exemplary Embodiment

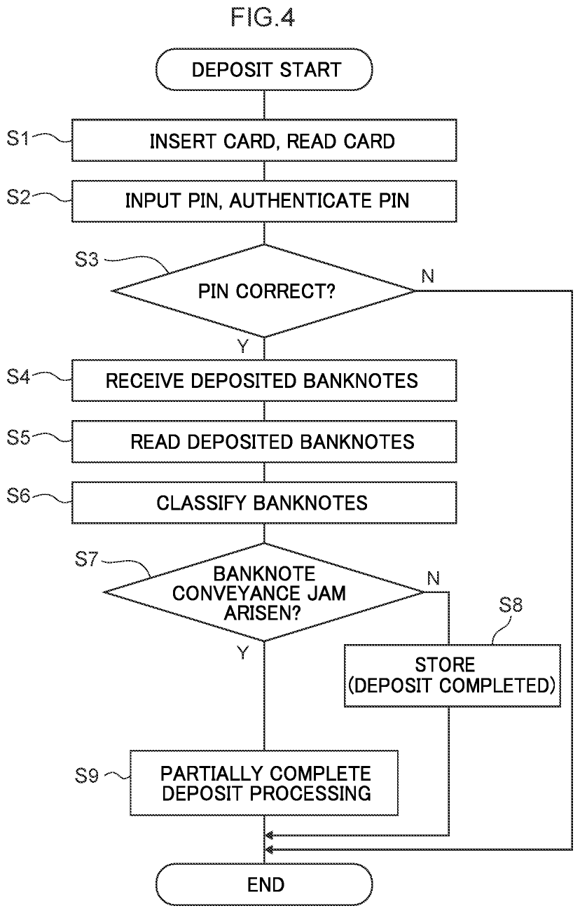

Next, explanation follows regarding a deposit operation by the banknote deposit/withdrawal device 100 of the present exemplary embodiment configured as described above. FIG. 4 illustrates a deposit processing flow of the first exemplary embodiment of the present disclosure.

First, the main control section 101 detects the approach of a user to the banknote deposit/withdrawal device 100 using a motion sensor, and displays a transaction menu on the operation/display section 104. As illustrated in FIG. 3, the main control section 101 receives press operation of a deposit processing key on the operation/display section 104 by the user, and displays a screen on the operation/display section 104 to prompt the user to insert a cash card and input a PIN. Next, the main control section 101 receives these user operations via the card reader/printer 103 and the operation/display section 104, and starts deposit processing. The main control section 101 reads the card inserted by the user using the card reader/printer 103 (step S1).

Next, the main control section 101 authenticates the cardholder's identity by receiving input of a pre-registered PIN to the operation/display section 104 by the user. The main control section 101 then communicates with the host computer HC to authenticate whether or not the input PIN is the correct PIN corresponding to the user account number (step S2).

In cases in which the input PIN is incorrect (step S3: N), next, the main control section 101 outputs a message that the PIN is incorrect to the operation/display section 104, and ends the processing.

In cases in which the input PIN is correct (step S3: Y), next, the main control section 101 opens the shutter over the opening of the banknote deposit/withdrawal port section 110 to allow depositing of banknotes. After detecting banknotes deposited by the user, and when the hand of the user cannot be detected, the main control section 101 closes the shutter of the banknote deposit/withdrawal port section 110 and receives the banknotes (step S4).

Next, the main control section 101 starts feeding out the banknotes from the banknote deposit/withdrawal port section 110. At the same time, the main control section 101 starts driving the conveyance path of the conveyance section 150, starts up the various units, and counts and images (reads) the banknotes one note at a time as they pass the imaging section PHD (step S5). Note that, for example, when the banknotes fed out from the banknote deposit/withdrawal port section 110 in the sequence 1, 2, 3, 4, 5 pass the imaging section PHD, the imaging section PHD generates JPEG format banknote identification data 1.JPEG, 2.JPEG, 3.JPEG, 4.JPEG; 5.JPEG as illustrated in FIG. 3.

The imaging section PHD generates the banknote identification data for the front faces of the passing banknotes, and notifies the main control section 101 thereof. The main control section 101 may generate the serial numbers of the read banknotes from the notified banknote identification data. The main control section 101 stores the JPEG format banknote image data files and/or the read banknote serial numbers as illustrated in FIG. 3 in its storage section in the banknote identification information storage section BIS in the sequence in which the banknotes passed the imaging section PHD.

Next, the banknotes that have passed the imaging section PHD proceed to the classification section 120. The main control section 101 uses the classification section 120 to classify the passing banknotes (step S6). Note that in cases in which a problem banknote is detected, the banknote deposit/withdrawal device 100 performs processing to return the problem banknote (anomalous banknote) to the user. Note that for ease of explanation, the flowchart of FIG. 4 illustrates an example in which all the classified banknotes are normal. The main control section 101 uses the classification section 120 to detect and classify the banknotes being conveyed to the storage boxes 141 to 145 by denomination, to count up the number of banknotes by classified denomination in its storage section, and to count the deposit amount to be stored in the storage boxes 141 to 145 based on the counted number of banknotes.

Next, the main control section 101 uses the detection sensors (not illustrated in the drawings) that are configured to detect banknotes being conveyed on the conveyance section 150 to determine whether or not a conveyance jam has arisen due to conveyed banknotes backing up or the like (step S7). In cases in which a conveyance jam has not arisen, the main control section 101 proceeds to the next step S8, and in cases in which a conveyance jam has arisen, the main control section 101 transitions to step S9.

In cases in which processing proceeds to step S8, the main control section 101 stores the banknotes in the storage boxes 141 to 145, and then overwrites a record table in its storage section with a serial number, account number, processing date and time, usage processing, counted amount, deposit amount, and the like as a result of the current deposit processing, and transmits to the host computer HC to make deposit complete. The main control section 101 then uses the card reader/printer 103 to issue the user with a deposit statement printed with the processing result, and ends the deposit processing.

On the other hand, in cases in which determination is made at step S7 that a conveyance jam has arisen, at step S9, the main control section 101 overwrites the record table in its storage section with the serial number, account number, user ID, processing date and time, usage processing, counted amount, and amount that has already been stored in the storage boxes 141 to 145 as a result of the deposit processing. The main control section 101 then transmits to the host computer HC to make deposit partially complete, uses the card reader/printer 103 to issue the user with a deposit statement printed with the deposit processing result, and ends the deposit processing. The main control section 101 that has determined that a conveyance jam has arisen then outputs display of a message that the transaction has been halted and a request to contact a call center (rectification request) on the screen of the operation/display section 104.

In the processing in which the deposit processing is partially complete, at step S9, the main control section 101 holds banknote information including the images of the banknotes and the read serial numbers within the device. The main control section 101 determines banknotes to be user banknotes (transaction incomplete banknotes) prior to classification inside the device when they have not passed a predetermined point on the conveyance section 150 (the points where the storage passage sensors SP1 to SP5 are provided at the banknote entry/exit ports of the storage boxes 141 to 145), and determines banknotes inside the device to be in-box banknotes (transaction complete banknotes) once they have passed any of these predetermined points.

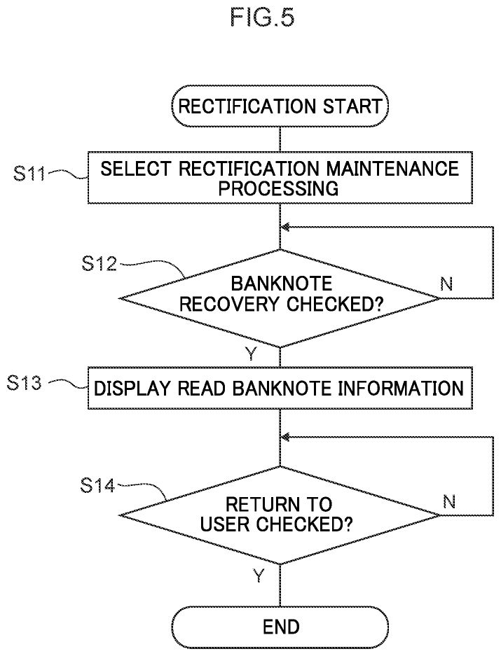

Next, explanation follows regarding rectification processing of the banknote deposit/withdrawal device 100 of the present exemplary embodiment. FIG. 5 illustrates a flow of banknote recovery and rectification processing performed by a maintenance technician after a fault has arisen in the first exemplary embodiment of the present disclosure.

First, the maintenance technician attending to the banknote deposit/withdrawal device 100 verifies a personal ID with the device, and performs a specific rectification processing operation (rectification maintenance processing selection: step S11). The main control section 101 receives this operation, and unlocks the device such that the device can be opened up. The maintenance technician then opens up the device, and takes out and recovers banknotes remaining on the conveyance path and respective units excluding the storage boxes 141 to 145 inside the device.

Next, the main control section 101 uses specific sensors and the like to perform processing to check that the maintenance technician has recovered the banknotes, and determines whether or not recovery of the banknotes by the maintenance technician has been checked (step S12).

Next, the main control section 101 displays information including the images and read serial numbers of the banknotes within the storage boxes on the operation/display section 104 (step S13). Note that the maintenance technician determines whether each extracted banknote is a user banknote or an in-box banknote by checking the displayed banknote images on the operation/display section 104. The maintenance technician decides whether or not each recovered banknote should be returned to the user, thus ending the processing (step S14).

The operation/display section 104 may be configured so as to display plural banknote images arranged sequentially on a banknote checking screen displayed thereon. Furthermore, the banknote images on such a banknote checking screen may be changeable, for example using an array configured of a button used to switch to display of fewer of the banknote images, a button used to reduce or enlarge the banknote images (zoom in or zoom out), a button to display a single image, buttons to scroll to the preceding page or the following page (by swiping or clicking), and so on.

As described above, in the first exemplary embodiment, the operation/display section 104 (information presentation section) is utilized to present the banknote identification information that is obtained from the banknote identification information storage section BIS and that is associated with detection results (banknote passage) by storage detection sections (storage passage sensors SP1 to SP5) of the storage boxes 141 to 145. Thus, when a fault arises during deposit and banknotes remain inside the device, a maintenance technician displays the images of the in-box banknotes and the read serial number information and compares the banknote images on the screen of the creation display section 11 with the recovered banknotes, thereby enabling the maintenance technician to accurately handle banknotes recovered from inside the device. Although the operation/display section 104 is utilized as an information presentation section, as a modified example, a liquid crystal display may be provided within the device casing as an information presentation section that is separate to the operation/display section 104.

Second Exemplary Embodiment

The present exemplary embodiment matches the first exemplary embodiment, with the exception of the point that in the first exemplary embodiment, the card reader/printer 103 (information presentation section) is utilized to present banknote identification information that is obtained from the banknote identification information storage section BIS and that is associated with detection results (banknote passage) by the storage detection sections (storage passage sensors SP1 to SP5) of the storage boxes 141 to 145. Accordingly, elements that are similar to those of the first exemplary embodiment are allocated the same reference numerals, and explanation thereof is omitted.

In contrast to the first exemplary embodiment, in the second exemplary embodiment, the equipment configuration is such that the card reader/printer 103 that is capable of printing on paper and the like is employed as a means to accurately check whether a remaining banknote is a user banknote or an in-box banknote.

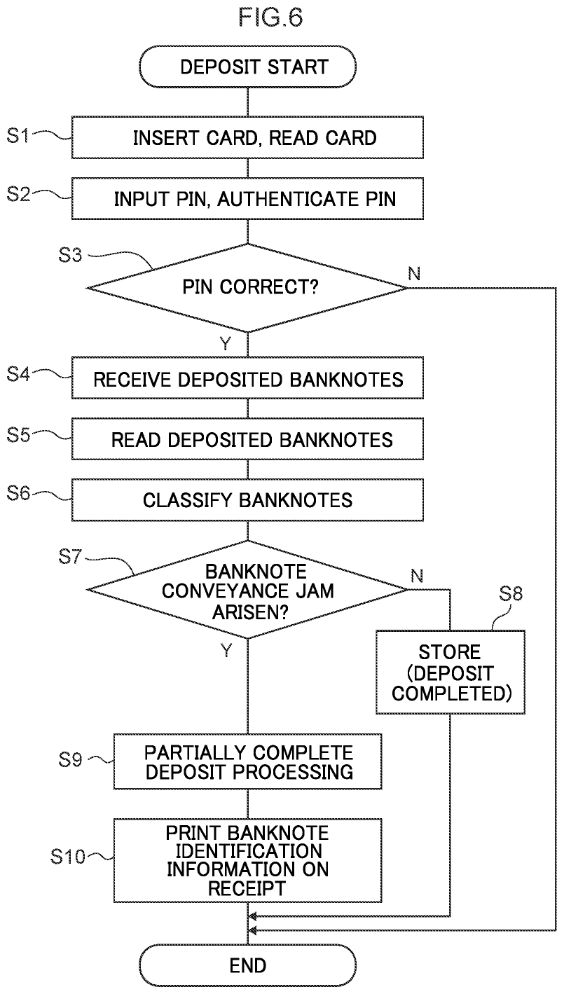

FIG. 6 illustrates a flow of transaction processing in the second exemplary embodiment. In a flow of deposit transaction processing in the second exemplary embodiment, in addition to image display of banknote identification information by the operation/display section 104 (information presentation section) as in the first exemplary embodiment, banknote identification information (number of banknotes and banknote information (serial numbers)) is printed on a receipt in an additional printing step (step S10). Other configuration is similar to that of the first exemplary embodiment.

A maintenance technician uses a balance inquiry result on the operation/display section 104 to check the number of recovered remaining banknotes against the number of banknotes that were in the possession of the user, enabling certainty regarding the total number of banknotes to be checked. Moreover, comparing the statement, in which banknote identification information is printed on a receipt due to the additional processing in the flow illustrated in FIG. 6, against the number of remaining banknotes and the balance inquiry result enables certainty regarding the number of banknotes to be improved.

Modified Examples of First and Second Exemplary Embodiments

In the first and second exemplary embodiments, explanation has been given regarding a deposit transaction. However, the banknote deposit/withdrawal device 100 may also be applied to a dedicated cash dispenser (CD) or a dedicated bill exchanger. In such cases, during a withdrawal transaction, the main control section 101 determines banknotes to be in-box banknotes (transaction complete banknotes) that are prior to classification inside the device when they have not been fed past a predetermined point on the conveyance section 150 (the points where the storage passage sensors SP1 to SP5 are provided at the banknote entry/exit ports of the storage boxes 141 to 145), and determines banknotes to be user banknotes (transaction incomplete banknotes) once they have passed any of these predetermined points.

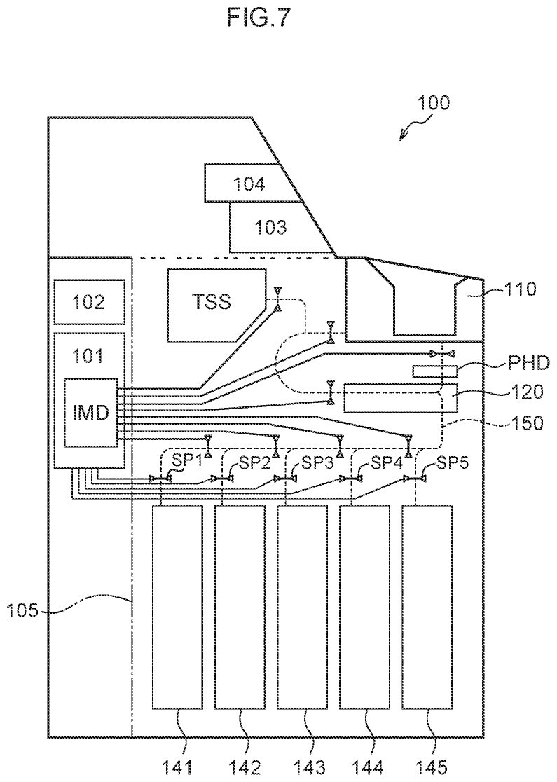

In the first and second exemplary embodiments, explanation has been given regarding an example in which a temporary storage section is not provided in the banknote deposit/withdrawal processing section 105 of the banknote deposit/withdrawal device 100. However, as illustrated in FIG. 7, a temporary storage section TSS may be installed and connected to the banknote deposit/withdrawal port section 110 and the classification section 120 via a conveyance path. A banknote deposit/withdrawal device installed with such a temporary storage section TSS is capable of obtaining similar advantageous effects to those of the first and second exemplary embodiments.

These modified examples also enable recovered banknotes to be returned following a check by a maintenance technician performing rectification processing (checking using a paper-based serial number printout similar to a banknote checking screen), and thus enable trouble relating to deposit and withdrawal of banknotes to be reduced.

The disclosure of Japanese Patent Application No. 2018-147671 is incorporated in its entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

1. A transaction device comprising:
a banknote deposit/withdrawal port section that receives at least one of a deposit banknote or a withdrawal banknote;
a storage box that stores banknotes;
a conveyance section including a conveyance path on which the banknotes are conveyed between the banknote deposit/withdrawal port section and the storage box;
a banknote identification information holding section that reads and holds banknote identification information of the banknotes conveyed on the conveyance path;
a storage detection section that detects the banknotes being stored in the storage box via the conveyance path or being fed out from the storage box via the conveyance path; and
an information presentation section that presents the banknote identification information obtained from the banknote identification information holding section associated with a detection result of the storage detection section in a case in which a fault event has arisen.

2. The transaction device of claim 1, wherein the information presentation section includes at least one of a device to print the banknote identification information with the sign whether the banknote should be returned to the user or not on a sheet, or a device to display the banknote identification information with the sign whether the banknote should be returned to the user or not on a screen.

3. The transaction device of claim 1, wherein the banknote identification information includes an image of a banknote conveyed on the conveyance path or a banknote identification code extracted from the image.

4. The transaction device of claim 3, wherein the banknote identification information includes a number of banknotes conveyed on the conveyance path.

5. The transaction device of claim 1, further comprising:
a user verification section that acquires user identification information to specify a rightful owner of a banknote received by the banknote deposit/withdrawal port section,
wherein the information presentation section presents the user identification information together with the banknote identification information.

6. The transaction device of claim 5, wherein the user verification section includes a reader that reads a cash card or a passbook, and the user identification information is account information obtained by the reader.

7. The transaction device of claim 1, wherein the transaction device is a deposit machine, a cash dispenser, or a bill exchanger.

8. The transaction device of claim 1, further comprising a temporary storage section and a classification section that are connected to the banknote deposit/withdrawal port section via a conveyance path.
